(19) United States
(12) Patent Application Publication
(10) Pub. No.: US 2013/0224365 A1
(43) Pub. Date: Aug. 29, 2013

(54) FROZEN BEVERAGE PORTIONS

(71) Applicant: Orly AVIDANILOVITCH, Givatayim (IL)

(72) Inventor: Orly AVIDANILOVITCH, Givatayim (IL)

(21) Appl. No.: 13/406,555

(22) Filed: Feb. 28, 2012

(51) Int. Cl. A23F 3/00; A23L 3/36

(52) U.S. Cl. 426/597

(57) ABSTRACT

A consumer product which includes a honey ingredient and at least a tea ingredient which are mixed together and frozen. The product may further include supplementary flavoring ingredients also frozen with the honey and tea ingredients. The product is adapted to be dissolved in a hot beverage, thereby flavoring a hot beverage. Specifically, the product is adapted to be dissolved in hot water to provide a beverage of sweetened tea.

### FIELD AND BACKGROUND OF THE INVENTION

The present invention relates to a frozen consumables and, more particularly, to a frozen portions for use in the preparation of hot or cold beverages.

The Chinese and Japanese have developed many tea centered rituals over the centuries. Until the beginning of the twentieth century, tea was prepared from crushed tea leaves with or without the use of some form of filtration to prevent leaf particles from pervading the final beverage. In general, tea made from free-lying tea leaves results in the tea leaves remaining in the drinking vessel and gathering at the bottom of the vessel or being imbibed. The invention of the teabag—which was patented at the beginning of the previous century and has been in commercial use since—saw the beginning of ready to use, prepackaged portions, for tea-making with no dregs. Unfortunately the teabag still suffers some drawbacks. Some of these drawbacks include: the need for brewing the tea (for some this a drawback, for other, more cultured, individuals this is an advantage); the wastage of quality tea, as many teabags have sufficient ingredients to prepare at least two cups of tea, but are discarded after a first use (not getting value for money, manufacturing wastage); and the remaining teabag waste which can be recycled but in most cases is discarded and ends up populating a landfill.

With busier life styles and an appetite for gadgets and ideas that simplify (at least theoretically) common tasks around the house and office, it would be useful and convenient to have a simple, easy and quick way to prepare a cup of tea or herbal beverage, whether hot or cold.

There exist in the art various granulized and powdered teas that can be added to hot and sometimes even to cold water resulting in a tea beverage. As with all powdered or granulated preparations, the base product may need to be supplemented with various ingredients for enhancing taste such as sugar, sweetener, honey, lemon, lemon juice, milk and others. The procedure of adding various ingredients to a single beverage (or a selection of beverages—such as making tea and coffee for guests) can become a lengthy and messy event. In particular, when adding honey to a hot beverage, spillage and a sticky mess are almost inevitable.

Herbal teas or more precisely herbal infusions have become ubiquitous. Often, herbal teas that come prepackaged in tea bags need to be left in hot water for an extended time in order to draw out the desired flavor. Also, herbal teas may need some kind of sweetener in order to realize and fully appreciate the particular taste. Preparing regular or specialized teas (e.g. Rooibos or Red Bush caffeine free tea) from ground or crushed tea leaves necessitates specialized equipment for preventing the particles from entering the final beverage.

It would be advantageous to have a preparation that included tea and/or herbal infusion concentrate which is instantly soluble in hot or in some cases even cold water, where the desired taste is immediately released into the beverage without insoluble particles or lengthy extraction periods.

It would be highly advantageous to have a single portion product, preferably frozen, which can be added to hot or cold liquid resulting in a ready-to-drink preparation.

### SUMMARY OF THE INVENTION

According to the present invention there is provided a consumer product, including a container that is partially filled with contents including a honey-like substance and at least one tea ingredient, wherein said container is adapted to store said contents at a temperature below 0 degrees Celsius so that the contents are frozen. The frozen contents are adapted to be thawed and dissolved in a preferably heated beverage, flavoring the beverage in the process.

According to further features in preferred embodiments of the invention described below, the honey-like substance is honey.

According to still further features in the described preferred embodiments the tea ingredient is an ingredient derived at least partially from a tea plant.

According to still further features the tea ingredient is derived at least partially from an herbal source.

According to still further features the honey-like substance has a substantially solid state (having a viscosity of about at least 1000 Poise) at frozen temperatures, a malleable state at ambient temperatures and a substantially free flowing state at high temperatures.

According to still further features the ambient temperatures are in a range from about 14° C. to about 25° C.

According to still further features in the malleable state the substance has a viscosity ranging from about 20 Poise to about 200 Poise.

According to still further features the ambient temperatures are in a range from about 14° C. to about 35° C.

According to still further features in the malleable state the honey-like substance has a viscosity ranging from about 20 Poise to about 600 Poise.

According to still further features the high temperatures are in a range from about 65° C. to about 100° C.

According to still further features in the substantially free-flowing state the honey-like substance has a viscosity ranging from about 10 Poise to about 0 Poise.

According to still further features the at least one tea ingredient is selected from the group consisting of: fluid tea concentrate, dry tea concentrate, crushed tea leaves, soluble herbal extract, fluid herbal infusion concentrate, dry herbal infusion concentrate.

According to still further features the product further includes at least one supplementary flavoring ingredient.

According to still further features the at least one supplementary flavoring ingredient is selected from the group consisting of powdered milk, lemon juice, lemon concentrate, chemical flavoring additives, natural flavoring additives, herbal concentrates.

According to still further features the honey-like substance and at least one tea ingredient are intimately mixed.

According to the present invention there is provided a method for preparing a consumer product, comprising the steps of (a) providing a honey-like substance; and (b) packaging at least one tea ingredient with the honey-like substance in a container.

According to further features, the honey-like substance is honey.

According to still further features the method further includes the steps of: (c) applying a freezing process to the container.

According to still further features the at least one tea ingredient is provided prior to applying the freezing process.

According to still further features the step of applying the freezing process is effected prior to the step of providing at least one tea ingredient and wherein a second freezing process is applied after the step of providing at least one tea ingredient.

According to still further features the method includes the steps of: (d) providing at least one supplementary ingredient to the container; and (e) freezing contents of the container.

According to still further features the step of providing at least one supplementary ingredient is effected prior to any other step.

According to still further features the freezing is effected by a flash freezing process.

According to still further features the frozen contents when added to a beverage, substantially dissolves in the beverage, flavoring the beverage.

According to still further features the frozen contents are operative to be dissolved in a beverage selected from the group including: a cold beverage, a luke-warm beverage, a warm beverage, and a hot beverage.

The next evolution of tea, is tea from a prepackaged substantially soluble portion with a substantially homogeneous form (i.e. not powdered or granulated), where one need only to add boiling water. There is no waste, preparation is instant, no other additives have to be included in the tea-making process and there is no mess or fuss. Dry-ingredient prepackaged portions with a single form factor will suffer from a shortened shelf life, and relatively fast flavor degradation. The current innovation, a paradigm shift in fact, is a frozen beverage preparation portion having a single form factor and preferably based on a substantially fluid/viscous ingredient such as honey. The fluid/viscous ingredient preferably envelops the other ingredients, binding them, and is frozen to result in a single portion having a known form which is immediately ready for use in a hot (or cold) beverage preparation. At least the viscous substance should bind the other ingredients, even if not completely enveloping them.

Manufacturers will include a smaller percentage of essential ingredients in the preparations, as the entire portion is soluble with no wastage, unlike a teabag which needs a relatively higher percentage of essential ingredients in order to provide the same end product. The additional expense of the teabag material, string, and in many cases, individual paper package can also be saved with the current innovation.

### BRIEF DESCRIPTION OF THE DRAWINGS

Various embodiments are herein described, by way of example only, with reference to the accompanying drawings, wherein:

FIG. 1 is an isometric front view of an exemplary embodiment of the immediate invention;

FIG. 2 is an isometric front view of an exemplary cubed product of the immediate invention with two layers;

FIG. 3 is an isometric front view of an embodiment of the invention where the cubed product has three distinct layers;

FIG. 4 is a front view the cubed product of FIG. 3 in a container with one wall deleted;

FIG. 5 is an isometric elevated front view of a tray for holding a plurality of food portions according to the immediate invention;

FIG. 6 is a chart of some typical values of viscosity versus temperature for clover honey.

### DESCRIPTION OF THE PREFERRED EMBODIMENTS

The principles and operation of a frozen beverage portion according to the present invention may be better understood with reference to the drawings and the accompanying description. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Physical Properties of Honey

The physical properties of honey vary, depending on water content, the type of flora used to produce it, temperature, and the proportion of the specific sugars it contains. Fresh honey is a supersaturated liquid, containing more sugar than the water can typically dissolve at ambient temperatures. At room temperature, honey is a supercooled liquid, in which the glucose will precipitate into solid granules. This forms a semisolid solution of precipitated sugars in a solution of sugars and other ingredients. Below 5° C., the honey will not crystallize and, thus, the original texture and flavor can be preserved indefinitely.

Since honey normally exists below its equilibrium or ‘melting point’, it is a supercooled liquid. At very low temperatures, honey will not freeze solid. Instead, as the temperatures become colder, the viscosity of honey increases. Like most viscous liquids, the honey will become thick and sluggish with decreasing temperature. While appearing or even feeling solid, it will continue to flow at very slow rates. Although honey does not freeze solid, reference is made here in to ‘freezing honey’ and ‘frozen honey’. These terms are to be understood, within the scope of this disclosure, to refer to honey at very low temperature where the honey appears to be substantially solid.

Temperature and moisture content are the main determinants of viscosity. Viscosity of Honey decreases rapidly as the temperature rises. A change of 1% moisture is equivalent to about 3.5° C. in its effect on viscosity. Nectar source will also have an impact on viscosity. In most cases this is minor but in the case of thixotropic honeys (for example manuka), this may be greater.

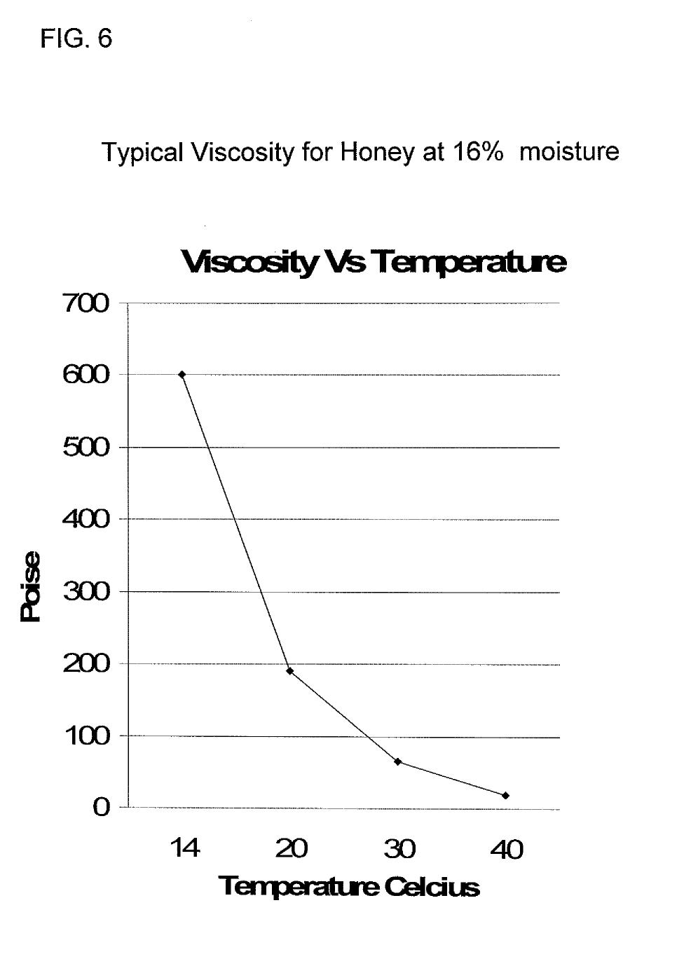

FIG. 6 is a chart of some typical values of viscosity versus temperature for clover honey according to the values detailed in the following chart:

At 16% moisture

| | | |
|---|---|---|
| 14° C. | 600 | poise |
| 20° C. | 190 | poise |
| 30° C. | 65 | poise |
| 40° C. | 20 | poise |
| 50° C. | 10 | poise |
| 70° C. | 3 | poise |

At 25° C.

| | | |
|---|---|---|
| 13.7% moisture | 420 | poise |
| 14.2% moisture | 270 | poise |
| 15.5% moisture | 138 | poise |
| 17.1% moisture | 70 | poise |
| 18.2% moisture | 48 | poise |
| 19.1% moisture | 35 | poise |
| 20.2% moisture | 20 | poise |
| 21.5% moisture | 14 | poise |

Generally speaking, for the purposes of this disclosure, the term ‘viscous’ generally refers to the substances having a viscosity at least as depicted in the graph (i.e. values falling on the graph or to the right thereof) unless otherwise corrected for moisture according to the general rule mentioned previously where a change of 1% moisture is equivalent to about 3.5° C. in its effect on viscosity.

Potentially, other substances having similar characteristics to honey (i.e. honey-like substances) can be used interchangeably with honey. The relevant physical characteristics of honey are that honey is a viscous substance that is sticky and can therefore be used to bind or envelop other ingredients at ambient temperatures (about 14° C. to 35° C.). At lower temperatures (<5° C.) the viscous substance becomes harder (between approximately 200 poise and 1000 poise) and substantially solid (>1000 poise). At high temperatures the substance becomes less viscous, thin and almost water-like, so that when mixed with warm or hot water the substance becomes intimately mixed with the water (or other liquid). The substance is edible. Finally, it is preferable, but not limiting that the honey-like substance be sweet, having the effect of sweetening the beverage it is intimately mixed with.

For the sake of clarity, a hot beverage (e.g. a hot cup of tea) is a beverage between 65 degrees Celsius and 69° C., a very hot cup of tea is 70 degrees Celsius and above. A warm or lukewarm beverage is 65 degrees Celsius or less.

For the purposes of this disclosure, the honey or honey-like substance has three relevant states: substantially solid, malleable (thick/viscous) and substantially free-flowing (thin or water-like). Honey is substantially solid (more than 1000 poise) when submitted to freezing or sub-zero temperatures as discussed above. Honey is thick or viscous (between about 20 and 200 poise) at ambient temperatures. Honey thins and becomes water-like (from about 10 poise and less) at high temperatures. The consumer product of the current invention is prepared at ambient temperatures where the honey is thick yet malleable and can be mixed with the other ingredients. The product is stored at freezing or sub-zero temperatures in accordance with the methods described below. The product is transformed into a consumable beverage at heated temperatures. Preferably the transformation is effected with hot fluid (i.e. >64° C. and <70° C.). More preferably the transformation is effected with very hot liquid (i.e. >69° C.). Less preferably the transformation is effected with warm or lukewarm liquid (i.e. <65° C. and >30° C.).

Tea

The term ‘tea’ is used herein to refer to the entire gamut of beverages that are referred to in the vernacular as ‘tea’ including herbal tea (even though botanically speaking there is a difference between tea and herbal infusions), unless otherwise stipulated. A ‘tea ingredient’, as referred to herein, is a wet or dry substance derived from the tea plant Camellia sinensis or from compounds used in the making of herbal tea infusions.

Freezing

Any applicable freezing process can be used for freezing the various elements of the consumer product of the immediate invention. The term ‘freezing’ is understood to mean ‘applying a freezing process’ where applicable. One exemplary freezing process is ‘flash freezing’ whereby perishable food items are frozen very quickly, as is well known in the art.

Form and Appearance

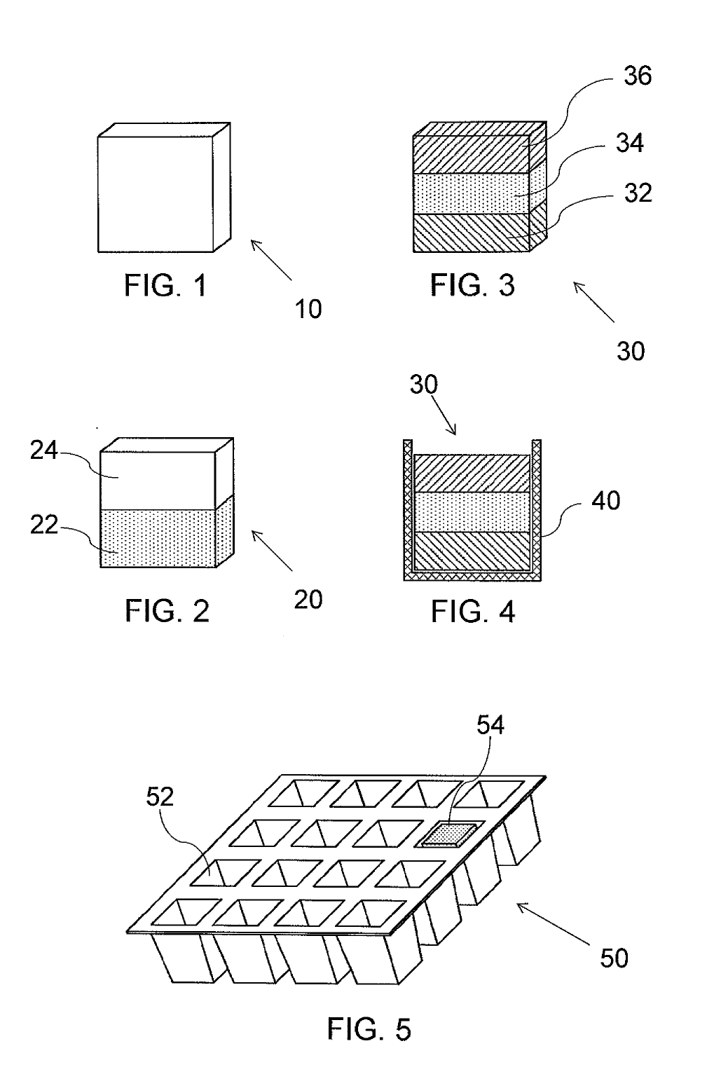

Referring now to the drawings, FIG. 1 illustrates a frozen preparation in a substantially cubed configuration. Consumer satisfaction with frozen garlic cubes has shown that a cubed frozen portion is both an appealing and a convenient form in which to package frozen ingredients. Less significantly, the current food product, as a complete beverage preparation which only lacks the addition of water, is distinct from frozen ingredients and additives such as frozen garlic. Furthermore, Frozen garlic cubes do not solve any of the drawbacks relating to tea preparation mentioned previously and are not ready-to-use food products in and of themselves. And finally, no existing products, whether wet or dry, solve the problem of honey dripping on countertops and additional ingredient spillage, or offer an all-in-one portion for tea preparation. Frozen preparations have a longer shelf life and are not susceptible to bug infestations.

Of course, the frozen preparation can have any dimensions or configuration as deemed most commercially successful or aesthetically pleasing. Furthermore, the frozen configurations may be configured to resemble a recognizable logo or object as desired. The preparations may incorporate advertizing materials, and to the same end, have a particular configuration and/or color. FIG. 1 depicts an isometric front view of an exemplary embodiment of the immediate invention as a cubed product 10, where the honey ingredient (or similar viscous binder) and the tea ingredient(s) have been intimately mixed resulting a substantially homogenous substance which can be frozen into any desired shape, such as, but not limited to, the depicted cube. FIG. 2 is an isometric front view of an exemplary cubed product 20 of the immediate invention with two layers 22, 24. Various options exist for providing the two-layered product. One exemplary option is to add a fluid ingredient (tea concentrate, herbal infusion, supplementary ingredient etc.) to a container or mold (bottom layer 22), freeze the contents (e.g. using a flash-freezing process) and then add the honey ingredient or the intimate mixture of FIG. 1 (top layer 24) and freeze the contents again. In an alternative option, the honey or honey and tea ingredient mixture can be added to the mold first (bottom layer 22). Thereafter the contents can either be frozen or left as is. A top layer 24 of tea ingredient or supplementary ingredient can be added (whether wet or dry) and then the entire contents frozen.

FIG. 3 depicts an isometric front view of an embodiment of the invention where the cubed product has three distinct layers. FIG. 4 depicts a front view the cubed product 30 of FIG. 3 in a container 40 with the front wall deleted. In FIG. 3, an exemplary cube 30 has three layers, a bottom layer 32, a middle layer 34 and a top layer 36. Middle layer 34 is honey/honey and tea mixture. Top layer 36 and bottom layer 32 can be the same substance or different substances. For example the bottom and top layer may both be a tea ingredient layer or one may be a tea ingredient layer and the other a supplementary ingredient layer. The layer may be a fluid layer including ingredients or dry ingredients. The fluid ingredients may include concentrate, chemical additives, natural additives (e.g. for flavoring or coloring and so forth). The dry ingredients may include powders, granules, tea leaves (e.g. whole, freeze-dried, crushed etc.), soluble ingredients, insoluble ingredients, natural flavoring additives (mint leaves, rosehip, lemon grass etc.) and so on. The dry ingredients can be added to the honey or honey mixture either before being poured into the mold/container, or after. The binding property of the honey will bind the added ingredient to the main/honey portion so that when frozen, the product is a single cube 30. More preferably the layers are formed by freezing fluid ingredients. In FIG. 3 a fluid ingredient is preferably added first to the container and then frozen (bottom layer 32). Thereafter the honey or intimate honey mixture is added (and either frozen or not frozen) (middle layer 34) and then a further fluid layer (top layer 36) is added above the honey layer. If the honey layer is not frozen then the liquid layer will generally not mix with the honey layer, even though some mixing may occur. If the honey layer is frozen then the top layer will not, in all likelihood, mix with the honey layer. The three layered configuration depicted in FIG. 3 and in FIG. 4 is preferable as the cube of this configuration can slide out easily, without any of the ingredients getting stuck to the bottom or sides of the container. Potentially, if the middle layer is frozen then a slight gap may have formed in some instances between the honey and the container wall (where the honey contracts in a substantial manner). When the third layer is added in a fluid form, some of the fluid may slip between the honey and the wall so that when subsequently frozen, the top layer not only covers over the cube but also partially encompasses the sides of the middle layer as well.

FIG. 5 is an isometric elevated front view of a tray 50 for holding a plurality of food portions according to the immediate invention. In some embodiments of the invention, the portions may be arranged on tray 50, having individual pockets 52 for housing the individual portions 54. The tray may include portions having the same flavor, or alternatively, a varied selection of flavored portions. In the former option, the packaging will detail the flavor or combination of flavors or a name/designation of the particular flavor of the portions. In the latter option, each portion will be separately labeled with the flavor or combination of flavors or name/designation (not shown). The label/name may printed on a transparent or semi transparent plastic film (not shown) covering the portions which is intended to be partially removed to afford access to the portions but remain attached so as to inform the consumer as to the nature of the portion for selection. Alternatively, the label/name may be printed on the underside of each portion pocket.

Generally, packaging will preferably include the flavor and/or derivation of the honey (if discernable) and the added flavors from the tea and/or herbal infusions. Exemplarily, the honey may have a ‘citrus taste’ and the tea a complementary ‘fruity’ taste or contrasting ‘bitter’ or ‘bland’ taste. Nutritional value and precise ingredients must appear on the packaging in a manner at least conforming with the local regulations that govern food packaging.

Manner of Use

In the depicted example of a frozen cube preparation, a user or consumer removes the package containing a tray or other organization of the frozen portions from the freezer. The selected portion is ejected (in a manner similar to the ejection of an ice cube from an ice tray or of a frozen garlic cube from a tray of frozen garlic cubes) from the housing pocket of the tray and placed in a cup or mug. Boiling water is added to the cup melting the cube and releasing the flavors consolidated therein. In some embodiments cold, room temperature or warm water may be added to the vessel containing the frozen preparation, in place of, or in addition to, the boiling water. Of course, fluids other than water may be added to the frozen preparation, according to taste. It is further made clear that although the most preferred manner of preparation is to add heated fluid to a vessel containing the frozen preparation or preparations, the frozen product can similarly alternatively be added to the vessel after the heated fluid has been added.

Ingredients and Components

The frozen preparation may be composed primarily from honey, honey extract, honey derivative or other substances having similar characteristics as honey as discussed above. The honey or honey-like ingredient serves as a basis for all other ingredients. The honey (or honey-like substance), aside from affording the sweetening effect to the beverage, also acts as a binding agent for the other ingredients. The supplementary ingredients may include some or all of: granulated and/or powdered herbal artifacts, granulated tea, powdered milk, liquid/fluid tea concentrate, liquid/fluid herbal concentrate. Less preferably, the supplementary ingredients may alternatively or additionally include ground or crushed tea leaves and/or herbal extracts (i.e. substances which are not soluble and will leave traces or ‘dregs’ at the bottom of the cup).

In a preferred embodiment, all ingredients included in the preparation are substantially soluble in water so that when water is poured over the frozen portion, the portion dissolves leaving a clear, dreg free, beverage, as would be found when using a tea bag. In some embodiments, a portion of the supplementary ingredients may not be substantially soluble. Ingredients such as freeze-dried ground/crushed tea leaves and other herbal components may only be partially soluble or completely insoluble.

Methods of Preparation

The preparation includes the primary component (honey or honey-like substances) and may be supplemented with one or more supplementary ingredients. The preparation is composed by adding dry or wet ingredients to the honey. Various methods of preparing the composition will be obvious to one skilled in the art. One exemplary method includes the following steps:

Step 1: select the type of honey. This selection may be based on one or more factors including: honey flavor, consistency, color, time to freeze, density and the like.

Step 2: add tea and/or herbal flavoring. Preferably all ingredients are derived naturally from natural sources (i.e. not chemically derived flavors but rather flavors extracted from tea leaves and herbal extracts using accepted practices resulting in a ‘natural’ product as opposed to ‘artificial flavoring’). The flavoring may be in a dry or wet state. For example, the tea flavoring may be in the form of granulated or powdered tea. In an alternative example the tea flavoring (or herbal infusion) may be in the form of a liquid concentrate. The flavoring is added to honey by adding the wet or dry ingredients to the relatively fluid honey and mixing the preparation. The preparation may attain a homogeneous consistency, (i.e. be uniform in composition all the way through) when using wet ingredients, or have a slightly heterogeneous constitution (i.e. some parts of the mixture are different from other parts of the mixture) when adding dry ingredients. It is clear that dry ingredients may not dissolve in the honey but should preferably be completely coated or enveloped by the honey. Both wet and dry ingredients should preferably be intimately mixed with the honey sufficiently so as to achieve as homogeneous a consistency as possible with the given ingredients while at the same time preventing some portions of the mixture having high concentrations of flavoring and other portions having low concentrations of flavoring. Due to the physical properties of honey (discussed above), it may be more convenient to heat the honey during production, or alternatively/additionally process the honey (mixing, apportioning) in a work area having a relatively high humidity so that the honey will have a relatively lower viscosity (as honey is hygroscopic, absorbing moisture from the air) and therefore be easier to mix with other ingredients and apportion into moulds and so on.

Step 3: divide the mixture/batch into separate standardized portions. This is preferably achieved by pouring the honey mixture into preconfigured portion moulds.

Step 4: freeze the portions. The portions may be ‘flash frozen’, or conventionally frozen. Freezing the portions ensures extended shelf (freezer) life and locks in the fresh flavoring which does not degrade over time or at least the flavor degradation is significantly slowed relative to similar non-frozen preparations. The portions may be packaged prior to freezing or thereafter.

In an alternative method:

Step 1: is the same as above.

Step 2: Honey is added to individual portion moulds in a predetermined quantity according to desired taste and consistency.

Step 3: Wet and/or dry tea and herbal infusion flavoring ingredients are added to each individual portion according to desired taste. In some compositions more than one flavoring ingredient may be added. The flavoring ingredients may be premixed prior to being added to the honey base or alternatively each flavoring may be added individually and therefore sequentially. Preferably all dry ingredients should be mixed with wet/fluid ingredients so as to bind the ingredients or the preparation into a single portion, whether prior to or during the freezing stage.

Step 4: freezing the portions and packaging.

Products created using the aforementioned method may have a substantially layered look. It is clear that more than three layers may be provided in a product.

In a further alternative method, step 2 includes adding a wet ingredient to the mould and then flash-freezing the wet ingredient. Honey or honey mixed with other ingredients is then added in a layer above the first frozen layer in a third step and also flash-frozen. Optionally, a third wet layer may be added before flash-freezing the portion a third time. This ‘frozen layered’ approach (with two or three layers) ensures that the portion is easily and cleanly ejected from the mould or container when so desired.

Supplementary Ingredients

In some embodiments of the invention the top and/or bottom layers may include a supplementary ingredient which is an enhancement for the tea or herbal tea of the basic product. Some common additives/‘supplementary ingredients’ include, but are in no way limited to the natural flavoring additives: lemon flavoring (liquid concentrate, powder, dehydrated fruit etc.), powdered milk (see below), mint leaves, derivatives from the mint family, hierba Luisa and any other type of leaf, grass, root, plant or herb that is added to tea beverages. The common characteristic of the supplementary ingredient is that the supplementary ingredient adds flavor or enhances the flavor of the beverage. The supplementary ingredient may also or alternatively be a chemically derived additive/flavoring.

Powdered Milk

A further obstacle to overcome is the inclusion of milk in the prepackaged frozen portion. In general, freezing milk is a tricky proposition and in some regions, local laws forbid frozen milk products. One solution for including milk in the frozen preparation is to add powdered milk to the preparation before freezing. The honey base of the preparation binds the powder so that both the fluid and frozen preparations remain substantially homogenous. When thawed/dissolved in boiling water, the powdered preparation is reconstituted into a fluid milk product and serves as a regular milk additive and is included in the general category of ‘supplementary ingredients’ discussed above.

In an alternative embodiment, the powdered milk can be packaged in a soluble gelatinous casing (similar to the capsule casing of medicaments) and added to the preparation before freezing. In this embodiment, the encased powdered milk is added to the individual portions during the step of filling the moulds with preparation portions. Once again, when water comes into contact with the portion, the casing is dissolved and the powder is reconstituted to serve as a regular milk additive.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A consumer product, comprising:
a container that is partially filled with contents including a honey-like substance and at least one tea ingredient, wherein said container is adapted to store said contents at a temperature below 0 degrees Celsius.

2. The consumer product of claim 1, wherein said honey-like substance is honey.

3. The consumer product of claim 1, wherein said tea ingredient is an ingredient derived at least partially from a tea plant.

4. The consumer product of claim 1, wherein said tea ingredient is derived at least partially from an herbal source.

5. The consumer product of claim 1, wherein said honey-like substance has a substantially solid state at frozen temperatures, a malleable state at ambient temperatures and a substantially free flowing state at high temperatures.

6. The consumer product of claim 5, wherein in said substantially solid state said substance has a viscosity of about at least 1000 Poise.

7. The consumer product of claim 5, wherein said ambient temperatures are in a range from about 14° C. to about 25° C.

8. The consumer product of claim 7, wherein in said malleable state said honey-like substance has a viscosity ranging from about 20 Poise to about 200 Poise.

9. The consumer product of claim 5, wherein said ambient temperatures are in a range from about 14° C. to about 35° C.

10. The consumer product of claim 9, wherein in said malleable state said honey-like substance has a viscosity ranging from about 20 Poise to about 600 Poise.

11. The consumer product of claim 5, wherein said high temperatures are in a range from about 65° C. to about 100° C.

12. The consumer product of claim 11, wherein in said substantially free-flowing state said honey-like substance has a viscosity ranging from about 10 Poise to about 0 Poise.

13. The consumer product of claim 1, wherein said at least one tea ingredient is selected from the group consisting of fluid tea concentrate, dry tea concentrate, crushed tea leaves, soluble herbal extract, fluid herbal infusion concentrate, dry herbal infusion concentrate.

14. The consumer product of claim 1, further comprising:
at least one supplementary flavoring ingredient.

15. The consumer product of claim 14, wherein said at least one supplementary flavoring ingredient is selected from the group consisting of: powdered milk, lemon juice, lemon concentrate, chemical flavoring additives, natural flavoring additives, herbal concentrates.

16. The consumer product of claim 1, wherein said honey-like substance and said at least one tea ingredient are intimately mixed.

17. A method for preparing a consumer product, comprising the steps of:
(a) providing a honey-like substance; and
(b) packaging at least one tea ingredient with said honey-like substance in a container.

18. The method of claim 17, wherein said honey-like substance is honey.

19. The method of claim 17, further comprising the steps of:
(c) applying a freezing process to said container.

20. The method of claim 19, wherein said at least one tea ingredient is provided prior to said applying of said freezing process.

21. The method of claim 19, wherein said step of applying said freezing process is effected prior to said step of providing said at least one tea ingredient and wherein a second freezing process is applied after said step of providing said at least one tea ingredient.

22. The method of claim 19, further comprising the steps of
(d) providing at least one supplementary ingredient to said container; and
(e) freezing contents of said container.

23. The method of claim 22, wherein said step of providing of said at least one supplementary ingredient is effected prior to any other step.

24. The method of claim 19, where said freezing is effected by a flash freezing process.

25. The method of claim 19, wherein said frozen contents when added to a beverage, substantially dissolves in said beverage, flavoring said beverage.

26. The method of claim 19, wherein said frozen contents are operative to be dissolved in a beverage selected from the group including: a cold beverage, a luke-warm beverage, a warm beverage, and a hot beverage.
